(19) United States
(12) Patent Application Publication
(10) Pub. No.: US 2024/0284446 A1
(43) Pub. Date: Aug. 22, 2024

(54) ENHANCEMENT IN CONFIGURED GRANT TRANSMISSION

(71) Applicant: Apple Inc., Cupertino, CA (US)

(72) Inventors: Weidong YANG, San Diego, CA (US); Dawei ZHANG, Saratoga, CA (US); Wei ZENG, Saratoga, CA (US); Chunxuan YE, San Diego, CA (US); Hong HE, San Jose, CA (US); Haitong SUN, Cupertino, CA (US); Huaning NIU, San Jose, CA (US)

(73) Assignee: Apple Inc., Cupertino, CA (US)

(21) Appl. No.: 18/441,142

(22) Filed: Feb. 14, 2024

Related U.S. Application Data
(60) Provisional application No. 63/446,257, filed on Feb. 16, 2023.

(51) Int. Cl. H04W 72/1268; H04L 1/1812; H04L 5/14; H04W 72/0446; H04W 72/21; H04W 72/232

(52) U.S. Cl. CPC H04W 72/1268; H04L 1/1812; H04L 5/1469; H04W 72/0446; H04W 72/21; H04W 72/232

(57) ABSTRACT

Disclosed herein are system, method, and computer program product embodiments for enhancement in configured grant transmission. An embodiment operates by receiving a configured grant (CG) configuration message configuring a plurality of CG physical uplink shared channel (PUSCH) transmission occasions (TOs) within a CG period. Next, the embodiment receives an information element indicating a time division duplexing (TDD) uplink-downlink (UL-DL) slot configuration. The embodiment then determines whether a particular CG PUSCH TO of the plurality of CG PUSCH TOs overlaps with a DL slot indicated by the TDD UL-DL slot configuration. Finally, in response to a determination that the particular CG PUSCH TO overlaps with the DL slot, the embodiment skips utilizing the particular CG PUSCH TO.

### CROSS REFERENCES

This application claims the benefit of U.S. Provisional Application No. 63/446,257 filed Feb. 16, 2023, titled “ENHANCEMENT IN CONFIGURED GRANT TRANSMISSION,” the content of which is herein incorporated by reference in its entirety.

### BACKGROUND

### Field

The described aspects generally relate to mechanisms for uplink resource allocation in a wireless communication system.

### Related Art

The 5G New Radio (NR) supports a wide range of use cases and applications operating over various bandwidths along with a diverse set of UEs with different performance and latency requirements. To reduce transmission latency, 5 G NR defines configured grant (CG) scheduling for uplink transmissions that pre-allocates radio resources to the UE and eliminates the need for requesting resources for each transmission.

### SUMMARY

Some aspects of this disclosure relate to apparatuses and methods for enhancement in CG transmission. For example, some aspects of this disclosure relate to configuring a user equipment (UE) with multiple CG physical uplink shared channel (PUSCH) transmission occasions (TOs) within a period and dynamically indicating the identity of utilized CG PUSCH TOs to a base station.

Some aspects of this disclosure relate to a UE that has a transceiver configured to enable wireless communication with a base station, and a processor communicatively coupled to the transceiver. The processor is configured to receive a CG configuration message configuring a plurality of CG PUSCH TOs within a CG period. The processor is further configured to receive an information element indicating a time division duplexing (TDD) uplink-downlink (UL-DL) slot configuration, and determine whether a particular CG PUSCH TO of the plurality of CG PUSCH TOs overlaps with a DL slot indicated by the TDD UL-DL slot configuration. Next, in response to a determination that the particular CG PUSCH TO overlaps with the DL slot, the UE skips utilizing the particular CG PUSCH TO.

According to some aspects, the processor is further configured to transmit, using the transceiver, uplink control information (UCI) to the base station. The UCI indicates a first CG PUSCH TO and a last PUSCH TO of the one or more CG PUSCH TOs utilized for transmission within the CG period. The UE then transmits, using the transceiver, PUSCH transmissions to the base station during one or more CG PUSCH TOs of the plurality of CG PUSCH TOs based on the UCI. According to some aspects, when the CG configuration is of Type 2, the UCI indicates a number of the plurality of CG PUSCH TOs utilized at activation for transmission, and the processor is further configured to receive, using the transceiver, downlink control information (DCI) configuring a plurality of PUSCH transmissions within the CG period, and determine a number of the plurality of CG PUSCH TOs configured within the CG period based on a number of the plurality of PUSCH transmissions indicated by the DCI.

According to some aspects, the processor is further configured to receive a PDCCH transmission indicating a dynamic uplink grant, where the PDCCH transmission comprises a DCI configuring a plurality of PUSCH transmissions, where a first PUSCH transmission of the PUSCH transmissions includes a UCI field indicating a number of one or more PUSCH transmissions of the plurality of PUSCH transmissions.

According to some aspects, the processor is further configured to determine a hybrid automatic repeat request (HARQ) process identifier (ID) corresponding to a first CG PUSCH TO of the one or more CG PUSCH TOs based on a symbol index of the first CG PUSCH TO, and increment the HARQ process ID corresponding to the first CG PUSCH TO by a predefined value to obtain a second HARQ process ID corresponding to a second CG PUSCH TO.

Furthermore, the processor is configured to receive a PDCCH transmission comprising a DCI configuring a plurality of PUSCH transmissions within the CG period, wherein the DCI indicates a HARQ process identity (ID) corresponding to the first PUSCH transmission of the plurality of PUSCH transmissions, according to some aspects.

This Summary is provided merely for purposes of illustrating some aspects to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1 illustrates an example wireless system implementing enhanced configured grant transmission, according to some aspects of the disclosure.

FIG. 2 illustrates a block diagram of an example system of an electronic device implementing enhancement in configured grant transmission, according to some aspects of the disclosure.

FIG. 3 illustrates an exemplary CG configuration, with multiple CG PUSCH transmission occasions (TOs) configured within each CG period, according to some aspects of this disclosure.

FIG. 4 illustrates an example of misalignment between CG periodicity and periodicity of data packet generation, according to some aspects of this disclosure.

FIG. 5 illustrates an exemplary field for dynamic indication of utilized CG PUSCH transmission occasions in encoded CG-UCI, according to some aspects of this disclosure.

FIG. 6 illustrates an exemplary CG configuration and TDD-UL-DL slot configuration, according to some aspects of this disclosure.

FIG. 7A illustrates an exemplary method performed by a UE implementing enhancement in configured grant transmission, according to some aspects of this disclosure.

FIG. 7B illustrates another exemplary method performed by a UE implementing enhancement in configured grant transmission, according to some aspects of this disclosure.

FIG. 8 is an example computer system for implementing some aspects or portion(s) thereof.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Use case scenarios for 5G NR include enhanced mobile broadband (eMBB), ultra-reliable low-latency communications (URLLC), and massive machine type communications (mMTC). These use cases cover a wide range of applications with highly diverse requirements. For example, eMBB is designed to cater to the large capacities needed to accommodate high user density scenarios, mMTC services are characterized by a massive number of sensors or connected devices which typically transmit low volume of non-delay sensitive data, and URLLC services refer to services that are expected to have exceptionally low latency and extremely high reliability.

In addition, 5G-Advanced is expected to support emerging extended reality (XR) services which include virtual reality (VR), augmented reality (AR), and mixed reality (MR) use cases. XR traffic requires low latency, high reliability, and high capacity. Furthermore, XR traffic characteristics include quasi-periodic traffic of large variable-size blocks at irregular intervals. Enhanced resource allocation schemes adapted to quasi-periodic traffic are needed to support the stringent low-latency requirements of XR services.

To address the above technological issues, embodiments herein provide enhanced configuration grant (CG) transmissions. Some aspects of this disclosure relate to configuring multiple CG PUSCH transmissions occasions in a period of a CG PUSCH configuration to reduce latency resulting from quasi-periodic traffic with variable-size packets. Additionally, some aspects of this disclosure relate to apparatus and methods for implementing dynamic indication of unused CG PUSCH occasions based on UCI by the UE.

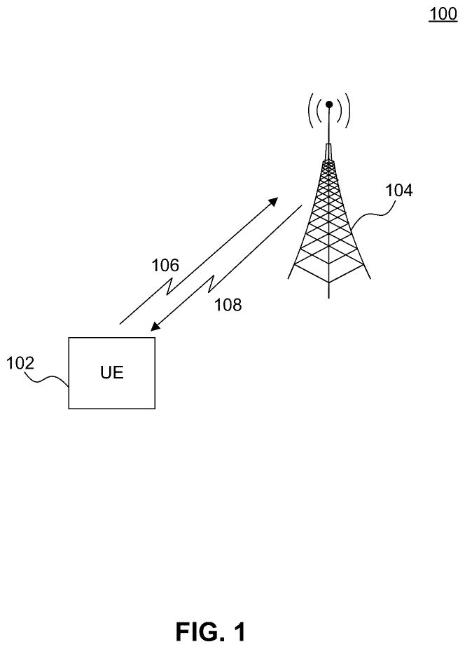

FIG. 1 illustrates an example wireless system 100 implementing enhanced configured grant transmission, according to some aspects of the disclosure. The example wireless system 100 is provided for the purpose of illustration only and does not limit the disclosed aspects. Wireless system 100 may include, but is not limited to, a base station 104 and a user equipment (UE) 102.

According to some aspects, base station 104 can be a fixed station or a mobile station. Base station 104 may be referred to as a cellular IoT base station, an evolved NodeB (eNB), a next generation node B (gNB), a 5G node B (NB), or some other equivalent terminology. In some examples, base station 104 can be interconnected to one another and/or to other base stations or network nodes in a network through various types of backhaul interfaces such as a direct physical connection, a virtual network, and/or the like, not shown.

According to some aspects, UE 102 can be configured to operate based on a wide variety of wireless communication techniques. These techniques can include, but are not limited to, techniques based on 3rd Generation Partnership Project (3GPP) standards. UE 102 can be stationary or mobile. UE 102 can be a cellular phone (e.g., a smart phone), a personal digital assistant (PDA), a wireless modem, a wireless communication device, a handheld device, a laptop, a desktop, a cordless phone, a wireless local loop station, a wireless sensor, a tablet, a camera, a video surveillance camera, a gaming device, a netbook, an ultrabook, a medical device or equipment, a biometric sensor or device, a wearable device (smart watch, smart clothing, smart glasses, smart wrist band, smart jewelry such as smart ring or smart bracelet), an entertainment device (e.g., a music or video device, or a satellite radio), a vehicular component, a smart meter, an industrial manufacturing equipment, a global positioning system device, an Internet-of-Things (IoT) device, a machine-type communication (MTC) device, an evolved or enhanced machine-type communication (eMTC) device, or any other suitable device that is configured to communicate via a wireless medium. For example, a MTC and eMTC device can include a robot, a drone, a location tag, and/or the like. Furthermore, UE 102 can be an augmented reality device, a virtual reality device, a mixed reality device, or the like.

According to some aspects, UE 102 may be capable of communicating with one or more base stations of the wireless system 100. According to some aspects, wireless system 100 may utilize one or more radio access technologies (RATs) and may have overlapping coverage from one or more RATs. According to some aspects, base station is an NR base station. An NR radio access network (RAN) includes NR base stations and a new radio core network (CN). An NR base station can be a next generation node B (gNode B). UE 102 can access an external network via an NR base station and the NR CN.

According to some aspects, base station 104 allocates physical layer resources for the uplink 106 and downlink 108. Indications of resource allocation are transmitted by base station 104 to UE 102 over PDCCH and/or RRC signaling. The resource allocation field in PDCCH is interpreted by UE 012 depending on the PDCCH DCI format. Base station 104 may configure uplink resources to UE 102 using either dynamic allocation or configured grant allocation.

With dynamic allocation, radio resources are dynamically allocated by base station 104 for each packet transmission in the uplink 106. According to some aspects, when UE 102 wants to transmit a packet in the UL using dynamic scheduling, the UE sends a scheduling request (SR) to the base station 104. According to some aspects, the SR is sent to the base station 104 over PUCCH. After the scheduling decision, the base station sends a grant message to the UE that contains information about the allocated resources. UE 102 can then transmit the packet using the allocated resources. If UE 102 was not able to transmit all data in the allocated resources, UE 102 may send a buffer status report to inform base station 104 about the amount of data pending to be transmitted. Based on the buffer status report, base station 104 can send an additional grant with information about the allocated resources to UE 102. UE 102 uses the additional data using the allocated resources. However, the signaling exchange between UE 102 and base station 104 to request and schedule resources results in non-negligible delay.

Uplink configured grant allocation aims to reduce the transmission latency, by bypassing transmission of a scheduling request prior to each PUSCH transmission. With a CG allocation, UE 102 can transmit within a set of predefined resource blocks on PUSCH without any explicit scheduling grants from base station 104, resulting in lower latency and signaling overhead.

There are two types of configured grant allocation: Type 1 and Type 2. In the Type 1 configured grant, the resource allocation is fully configured and released using RRC signaling. Specifically, RRC configures UE 102 with uplink time and frequency resource allocation, including periodicity of CG resources and time offset. In the Type 2 configured grant, the resource allocation is partially configured using RRC signaling but is subsequently activated and deactivated using PDCCH transmissions. According to some aspects, RRC configures the periodicity of the configured grant, but PDCCH provides the uplink time and frequency resource allocation.

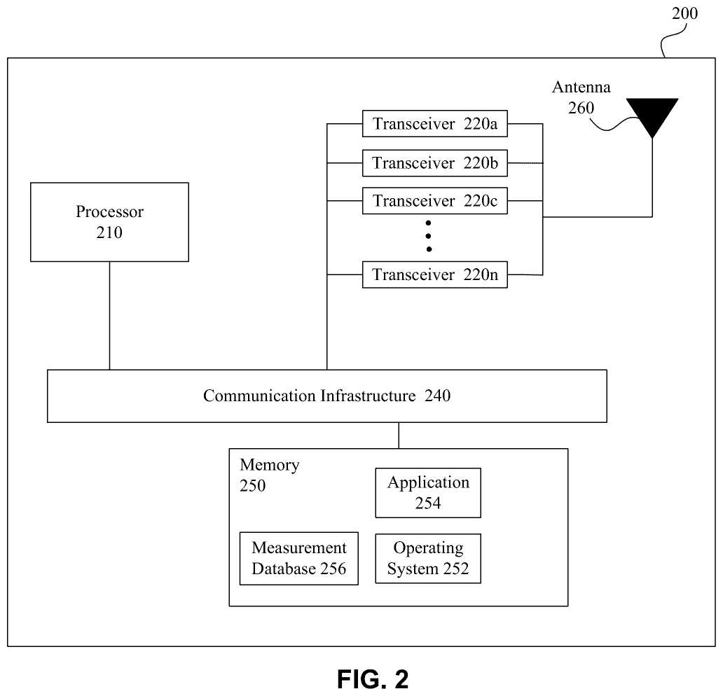

FIG. 2 illustrates a block diagram of an example system 200 of an electronic device implementing enhanced configured grant transmissions, according to some aspects of the disclosure. System 200 may be any of the base stations 101 or 107, and/or UE 103 of system 100. System 200 includes processor 210, one or more transceivers 220a-220n, communication infrastructure 240, memory 250, operating system 252, application 254, and antenna 260. Illustrated systems are provided as exemplary parts of system 200, and system 200 can include other circuit(s) and subsystem(s). Also, although the systems of system 200 are illustrated as separate components, the aspects of this disclosure can include any combination of these, less, or more components.

Memory 250 may include random access memory (RAM) and/or cache, and may include control logic (e.g., computer software) and/or data. Memory 250 may include other storage devices or memory such as, but not limited to, a hard disk drive and/or a removable storage device/unit. According to some examples, operating system 252 can be stored in memory 250. Operating system 252 can manage transfer of data from memory 250 and/or one or more applications 254 to processor 210 and/or one or more transceivers 220a-220n. In some examples, operating system 252 maintains one or more network protocol stacks (e.g., Internet protocol stack, cellular protocol stack, and the like) that can include a number of logical layers. At corresponding layers of the protocol stack, operating system 252 includes control mechanism and data structures to perform the functions associated with that layer.

According to some examples, application 254 can be stored in memory 250. Application 254 can include applications (e.g., user applications) used by wireless system 200 and/or a user of wireless system 200. The applications in application 254 can include applications such as, but not limited to, radio streaming, video streaming, remote control, and/or other user applications.

System 200 can also include communication infrastructure 240. Communication infrastructure 240 provides communication between, for example, processor 210, one or more transceivers 220a-220n, and memory 250. In some implementations, communication infrastructure 240 may be a bus. Processor 210 together with computer instructions stored in memory 250 performs operations enabling system 200 of system 100 to implement enhanced configured grant transmissions, according to some aspects of the disclosure, as described herein. Alternatively, processor 210 can be “hard-coded” to implement enhanced configured grant transmissions, as described herein.

One or more transceivers 220a-220n transmit and receive communications signals that support getting UE 102 into service on a NR cell based on carrier bandwidth, according to some aspects, and may be coupled to antenna 260. Antenna 260 may include one or more antennas that may be the same or different types. One or more transceivers 220a-220n allow system 200 to communicate with other devices that may be wired and/or wireless. In some examples, one or more transceivers 220a-220n can include processors, controllers, radios, sockets, plugs, amplifiers, filters, buffers, and like circuits/devices used for connecting to and communication on networks. According to some examples, one or more transceivers 220a-220n include one or more circuits to connect to and communicate on wired and/or wireless networks.

According to some aspects, one or more transceivers 220a-220n can include a cellular subsystem, a WLAN subsystem, and/or a Bluetooth™ subsystem, each including its own radio transceiver and protocol(s) as will be understood by those skilled arts based on the discussion provided herein. In some implementations, one or more transceivers 220a-220n can include more or fewer systems for communicating with other devices.

In some examples, one or more transceivers 220a-220n can include one or more circuits (including a WLAN transceiver) to enable connection(s) and communication over WLAN networks such as, but not limited to, networks based on standards described in IEEE 802.11. Additionally, or alternatively, one or more transceivers 220a-220n can include one or more circuits (including a Bluetooth™ transceiver) to enable connection(s) and communication based on, for example, Bluetooth™ protocol, the Bluetooth™ Low Energy protocol, or the Bluetooth™ Low Energy Long Range protocol. For example, transceiver 220n can include a Bluetooth™ transceiver.

Additionally, one or more transceivers 220a-220n can include one or more circuits (including a cellular transceiver) for connecting to and communicating on cellular networks such as 5G NR and the like. For example, one or more transceivers 220a-220n can be configured to operate according to one or more of Rel-15, Rel-16, Rel-17, or other of the 3GPP standards.

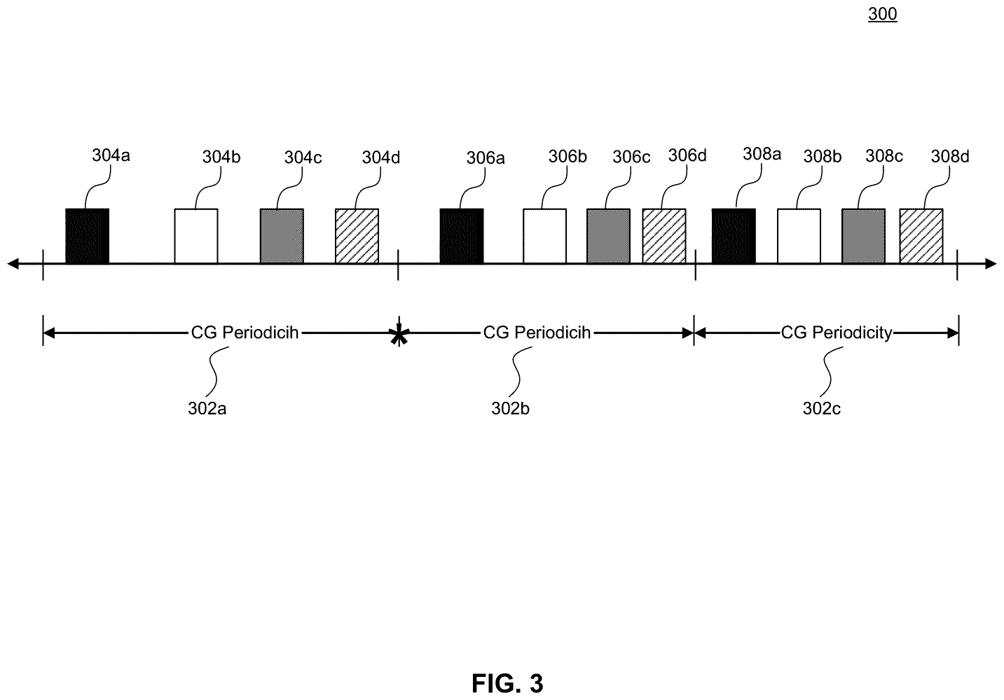

FIG. 3 illustrates an exemplary CG configuration 300, with multiple CG PUSCH transmission occasions (TOs) configured within each CG period. A CG configuration is a pattern of periodic uplink allocations granted to UE 102, according to some aspects of this disclosure. In the example CG configuration 300, CG PUSCH TOs 304a-d are configured within CG period 302a, CG PUSCH TOs 306a-d are configured within CG period 302b, and CG PUSCH TOs 308a-d are configured within CG period 302c. According to some aspects, a different number of CG PUSCH TOs can be configured within each CG periodicity. Furthermore, the time gap between subsequent CG PUSCH TOs in a CG period can be equal. Alternatively, to support quasi-periodic traffic, the time gap between subsequent CG PUSCH TOs within a CG period may be unequal and/or dynamically determined.

According to some aspects, during each CG periodicity, UE 102 can be configured to transmit different data over each CG PUSCH TO (i.e., CG transmission without repetition). For example, when a packet arrives for uplink transmission at the beginning of CG periodicity 302a, UE 102 transmits the packet during CG PUSCH TOs 304a. If a second packet arrives before CG PUSCH TO 304b, based on the size of the packet, UE 102 may transmit the packet during one or more CG PUSCH TOs starting with 304b (e.g., 304b-c). However, if the second packet arrives during PUSCH TO 304b or after CG PUSCH TO 304b, but before CG PUSCH TO 304c, based on the size of the packet, UE 102 may transmit the packet during one or more CG PUSCH TOs starting with 304c (e.g., 304c-d).

According to some aspects, UE 102 can be configured with multiple active CG configurations to serve a plurality of traffic with different patterns and characteristics.

According to some aspects, CG configuration 300 can be a Type 1 CG configuration. For CG configuration of Type 1, time domain resources can be allocated for the PUSCH using RRC signaling. According to some aspects, UE 102 can be configured with CG configuration 300 of Type 1 with multiple CG PUSCH TOs per CG period using RRC signaling. More specifically, for CG configuration of Type 1, RRC may configure the following parameters: periodicity of the configured grant of Type 1; the offset of a resource with respect to system frame number (SFN) zero in time-domain; time-domain parameters, which include the start symbol and the length of the assignment; and the number of HARQ processes.

According to some aspects, CG configuration 300 can be a Type 2 CG configuration. For CG configuration of Type 2, the time-domain resource allocation can be provided jointly by RRC parameters and by DCI sent to UE 102 over PDCCH. According to some aspects, UE 102 can be configured with CG configuration 300 of Type 2 with multiple CG PUSCH TOs per CG period using a combination of RRC signaling and DCI. More specifically, in DCI, the time-domain allocation can be derived from the value in the DCI's time-domain resource assignment (TDRA) filed indexed to a row in an allocation table in RRC. The indexed row defines the slot offset and the start and length indicator value (SLIV) indicating a start allocation symbol and allocation length.

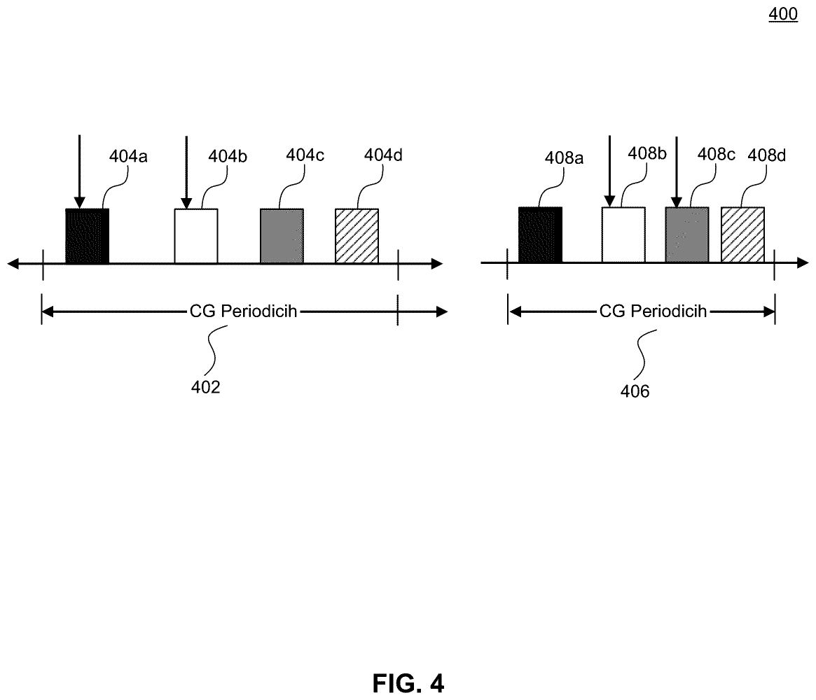

FIG. 4 illustrates an example of misalignment between CG periodicity and periodicity of data packet generation. XR traffic characteristics include quasi-periodic traffic of large variable-size blocks at irregular intervals. Due to the quasi-periodic nature of XR traffic, a packet may arrive at the beginning of a CG period, or it may arrive at a later point in time during a CG period. Configuring multiple CG PUSCH TOs every CG period results in reduced transmission latency, as explained below.

In the example of FIG. 4, a data packet arrives at the beginning of the CG period 402 and can be transmitted without delay during CG PUSCH TO 404a. Furthermore, if the data packet arrives during CG PUSCH TO 404a or after CG PUSCH TO 404a, but before CG PUSCH TO 404b, the packet can be transmitted during CG PUSCH TO 404b. However, on the other hand, if only a single PUSCH TO is scheduled during CG period 402, the packet would be buffered until the next CG period, which adds to transmission latency. Hence, configuring multiple CG PUSCH TOs every CG period results in reduced transmission latency.

Due to variability in the arrival time of the packets, some of the CG PUSCH TOs in a CG period might be left unused. According to some aspects, the efficiency of utilizing multiple CG PUSCH TOs every CG period can be enhanced by implementing dynamic indication of unused CG PUSCH TOs. According to some aspects, UE 102 can send a dynamic indication of utilized CG PUSCH TOs in a CG period to base station 104 using uplink control information (UCI).

According to some aspects, UE 102 can send a dynamic indication of the number of CG PUSCH TOs utilized in a CG period to base station 104. For example, in FIG. 4, CG PUSCH TOs 404a and 404b are utilized during CG period 402, and UE 102 may send an indication that two CG PUSCH TOs are utilized. Similarly, CG PUSCH TOs 404b and 404c are utilized during CG period 406, and UE 102 may send an indication that two CG PUSCH TOs are utilized. However, if base station 104 only receives the packet transmitted over CG PUSCH TO 408b, and does not receive the packet transmitted over CG PUSCH TO 408a, base station 104 cannot determine the identity of the utilized resources (i.e., whether the utilized TOs were 404b-c or 404a-b). Hence, to avoid such ambiguity, UE 102 can transmit a UCI that indicates the first CG PUSCH TO that was utilized, and the last PUSCH TO that was utilized within a CG period, according to some aspects. Alternatively, UE 102 can transmit a UCI that indicates the last CG PUSCH TO that was utilized, and the number of PUSCH TOs that were utilized within a CG period, according to some aspects. Alternatively, UE 102 can transmit a UCI that indicates the first CG PUSCH TO that was utilized, and the number of PUSCH TOs that were utilized within a CG period, according to some aspects.

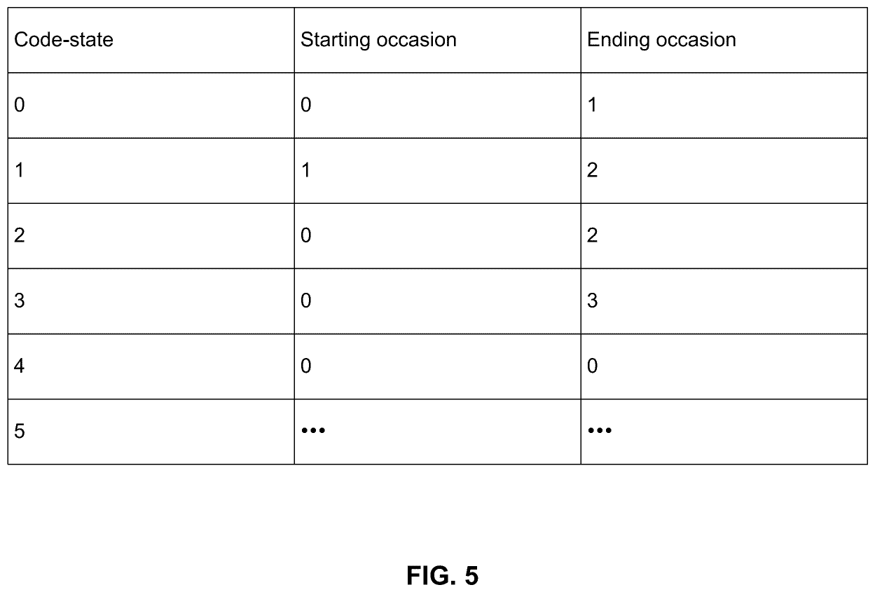

FIG. 5 illustrates a code-state field that UE 102 can be included in a CG UCI. According to some aspects, the code-state is a numeric value that indicates the starting CG PUSCH TO and the ending CG PUSCH TO that were utilized during a CG period. According to some aspects, UE 102 can transmit UCI with a UCI field or UCI component which signals such a code-state over a physical uplink control channel (PUCCH). Alternatively, UE 102 can transmit UCI with a UCI field which signals such a code-state over a PUSCH, according to some aspects.

As illustrated in FIG. 5, a code-state of 0 indicates that the first two CG PUSCH TOs were utilized, a code-state of 1 indicates that the two CG PUSCH TOs (the second CG PUSCH TO and the third CG PUSCH TO) were utilized, a code-state of 2 indicates that the first three CG PUSCH were utilized, according to some aspects. Furthermore, the number of binary bits that the code-state field comprises determines the maximum number of CG PUSCH TOs that can be scheduled with a CG period. According to some aspects, the base station can make the unused CG PUSCH TOs available for use by other UEs.

According to some aspects, when CG configuration is of Type 2 CG, the transmission occasion located right after receiving a CG activation is usually the first utilized CG PUSCH TO within that CG period. Hence, for Type 2 CG, UE 102 can indicate the number of utilized TOs in a UCI, instead of indicating the starting and ending TOs that were utilized. The first CG PUSCH TO after CG activation is considered as the first utilized TO. According to some aspects, for Type 2 CG, UE 102 includes a code-state field in UCI. The code-state can be a numeric value that indicates the number of CG PUSCH TOs that were utilized during a CG period.

Referring back to FIG. 3, for Type 2 CG, the maximum allowed number of CG PUSCH TOs per CG period can be configured using RRC signaling. According to some aspects, the base station can send the UE an RRC message, providing UE 102 with a CG configuration. The RRC message can include an information element that indicates the number of maximally allowable occasions in a CG period.

Alternatively, the maximum allowed number of CG PUSCH TOs per CG period is not indicated by RRC signaling. Instead, base station 104 can indicate the maximum allowed number of CG PUSCH TOs per CG period using DCI for Type 2 CG. Indicating the maximum allowed number of CG PUSCH TOs using DCI can provide base station 104 with greater flexibility in scheduling CG PUSCH transmissions. According to some aspects, for CG configuration of Type 2, PDCCH addressed to UE 102 can indicate activation of the uplink CG. Furthermore, DCI included in the PDCCH can trigger multiple PUSCH transmissions. Therefore, the number of maximally allowable occasions can correspond to the number of PUSCH transmissions from the triggering DCI. Furthermore, the time gap between adjacent PUSCH transmissions may be equal. Alternatively, the time gap between subsequent may be unequal. Accordingly, the number of maximally allowable occasions in a CG period are indicated by the DCI triggering multiple PUSCH transmissions, according to some aspects.

According to some aspects, the list of PUSCH transmissions triggered can be represented using a slot offset and a start and length indicator value (SLIV) for each PUSCH transmission. Each PUSCH transmission can be associated with a different slot offset. However, a single SLIV can correspond to all the triggered PUSCH transmissions. Furthermore, each PUSCH transmission may be associated with a different modulation and coding scheme (MCS) level. In some aspects, RRC signaling indicates the MCS level adjustment for each PUSCH transmission. For example, in FIG. 3, RRC signaling may indicate MCS level adjustments of m1, m2, m3 and m4 for the four CG PUSCH TOs 308a, 308b, 308c, and 308d, respectively. With M being the MCS level indicated in the DCI, the adjusted MCS levels for CG PUSCH TOs 308a, 308b, 308c, and 308d are determined as (M+m1), (M+m2), (M+m3), and (M+m4), respectively.

According to some aspects, for CG configuration of Type 1, the time gap between adjacent PUSCH transmissions (i.e., the time gap between subsequent C PUSCH TOs) may or may not be equal, depending on the RRC configured PUSCH transmissions. The list of PUSCH transmissions configured can be represented using a slot offset and a SLIV for each PUSCH transmission. Each PUSCH transmission can be associated with a different slot offset. However, a single SLIV can correspond to all the triggered PUSCH transmissions. Furthermore, each PUSCH transmission may be associated with a different MCS level. In some aspects, RRC signaling may indicate the MCS level adjustment for each PUSCH transmission. For example, in FIG. 3, RRC signaling may indicate a list of MCS levels for the four CG PUSCH TOs 308a, 308b, 308c, and 308d as: {M1′, M2′, M3′, M4′}.

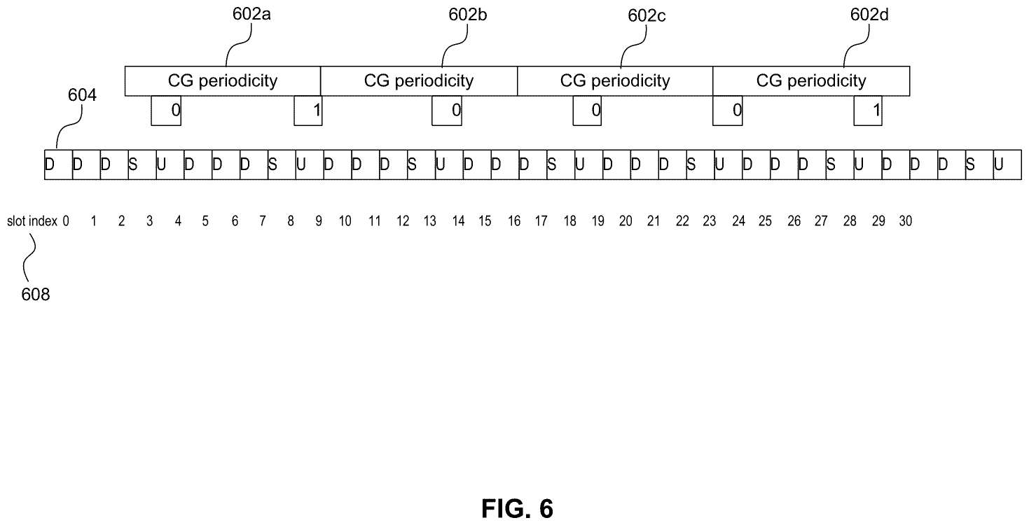

FIG. 6 illustrates an example time division duplex (TDD) uplink-downlink (UL-DL) slot configuration over multiple CG periods 602a-d, according to some aspects of this disclosure. According to some aspects, base station 104 provides UE 102 with a specific UL-DL transmission pattern using radio resource control (RRC) signaling. A semi-static uplink-downlink slot configuration provided by RRC can remain valid until reconfigured by a subsequent RRC. The TDD UL-DL slot configuration can be provided using information elements tdd-UL-DL-ConfigurationCommon and tdd-UL-DL-ConfigurationDedicated.

According to some aspects, tdd-UL-DL-ConfigurationCommon is broadcast from base station 104 to UE 102 as part of RRC system information block 1 (SIB1). Information element tdd-UL-DL-ConfigurationCommon specifies the following parameters corresponding to the TDD UL-DL slot configuration: UL-DL transmission periodicity, number of downlink slots at the start of each period, number of uplink slots at the end of each period, number of downlink symbols within the slot which follows the downlink slots, and number of uplink symbols within the slot which precedes the uplink slots. According to some aspects, the information element tdd-UL-DL-ConfigurationDedicated can be used to refine the UL-DL transmission pattern provided by the information element tdd-UL-DL-ConfigurationCommon.

According to some aspects, for a given TDD UL-DL slot configuration, there could be a misalignment between the periodicity of a CG configuration and the periodicity of the UL_DL transmission. For example, as illustrated in FIG. 6, during the first CG period 602a, two uplink slots (slots 4 and 9) of the TDD UL-DL slot configuration 604 overlap with CG period 602a, and hence, two allowable CG PUSCH TOs are available. However, during the second CG period 602b, only one uplink slot (slot 14) of the TDD UL-DL slot configuration 604 overlaps with CG period 602b, and hence only a single allowable CG PUSCH TO is available. Similarly, CG period 602c has a single allowable CG PUSCH TO. CG period 602d, on the other hand, has a two allowable CG PUSCH TOs.

According to some aspects, the semi-static CG allocation can be relaxed to account for the misalignment between the periodicity of a CG configuration and the periodicity of the UL_DL transmission. Accordingly, the time gap between subsequent CG PUSCH TOs can be derived based on the overlap between CG configuration and TDD UL-DL slot configuration 604, according to some aspects. Hence, UE 102, determines whether a particular CG PUSCH TO of its active CG configuration overlaps with a DL slot or a DL symbol indicated by the TDD UL-DL slot configuration, and if there is an overlap, UE 102 skips utilization over the particular CG PUSCH TO. However, if the particular CG PUSCH TO does not overlap with a DL slot or a DL symbol indicated by the TDD UL-DL slot configuration, the CG PUSCH TO is designated as an allowable CG PUSCH TO. UE 102 may utilize a CG PUSCH TO that is designated as an allowable CG PUSCH TO. Alternatively, TDD UL-DL slot configuration 604 may be taken into account during configuring UE 102 with CG configuration and the time gap between the multiple CG PUSCH TOs may be determined to avoid overlap with DL slots of the TDD UL-DL slot configuration.

Referring back to FIG. 3, configuring multiple CG PUSCH transmission occasions within each CG period necessitates enhancements to hybrid automatic repeat request (HARQ) procedures in the uplink 106 and the downlink 108.

In the case of CG configuration with a single PUSCH TO per CG period (i.e., CG transmission without repetition), the HARQ process ID corresponding to the CG PUSCH TO is calculated based on the information received via RRC signaling, as specified in TS 38.321. Similarly, in the case where a single transmission block is transmitted repeatedly over multiple CG PUSCH TOs in a CG period (i.e, CG transmission with repetition), only a single HARQ process ID may be needed, and the HARQ process ID can be calculated using the information received via RRC signaling as specified in TS 38.321.

However, in the case where multiple CG PUSCH TOs per CG period are configured for transmitting different transmission blocks over the different CG PUSCH TOs, as in the example illustrated in FIG. 3, enhancements to hybrid automatic repeat request (HARQ) procedures are needed to determine HARQ process IDs corresponding to each of the multiple CG PUSCH TOs.

According to some aspects, when multiple CG PUSCH TOs are configured per CG period for transmitting a different transmission block over each of the multiple CG PUSCH TOs, HARQ process ID corresponding to the first CG PUSCH TO can be calculated using the following example equation:

$$HARQ \text{} Process \text{} \text{} ID = \\ [ floor ( CURRNT\_Symbol / periodicity ) ] \text{} modulo nrofHAEQ - Process .$$

In the above equation, Current_Symbol=(SFN×SlotsPerFrame×SymbolsPerSlot)+(SlotNumber×SymbolsPerSlot)+SymbolNumber. The SlotsPerFrame depends on the numerology (e.g., subcarrier spacing) and the SymbolsPerSlot can depend on the applied cyclic prefix (e.g., 14 symbols per slot for a normal cyclic prefix and 12 symbols per slot for an extended cyclic prefix). The SFN, SlotNumber, and the SymbolNumber correspond to the system frame number (SFN), slot number, and symbol number within which the PUSCH starts (i.e., the first CG PUSCH TO).

According to some aspects, HARQ process ID corresponding to the first CG PUSCH TO is determined using the above equation. The HARQ process IDs corresponding to subsequent utilized CG PUSCH TOs can be obtained by incrementing the HARQ process ID corresponding to the first CG PUSCH TO by a predefined number. As an example, in FIG. 3, the HARQ process ID corresponding to CG PUSCH TO 304b can be obtained by incrementing the HARQ process ID corresponding to CG PUSCH TO 304a by value k1, the HARQ process ID corresponding to CG PUSCH TO 304c can be obtained by incrementing the HARQ process ID corresponding to CG PUSCH TO 304b by value k2, and the HARQ process ID corresponding to CG PUSCH TO 304d can be obtained by incrementing the HARQ process ID corresponding to CG PUSCH TO 304c by value k3. According to some aspects, the values of k1, k2, and k3 can be equal. Alternatively, the values of k1, k2, and k3 can be different from each other, according to some aspects,

According to some aspects, a HARQ process ID can be indicated by the UE in a CG-UCI, and a CG-UCI can be included in every CG PUSCH transmission. In such a case, the HARQ process ID corresponding to a CG PUSCH TO may be included in the CG-UCI transmitted during that CG PUSCH TO. Accordingly, when HARQ ID field is part of CG-UCI, the HARQ process ID may be provided by the UE over a PUCCH or over a PUSCH.

According to some aspects, a CG-UCI may not be configured to indicate a HARQ process ID (e.g., HARQ ID field is not included in a CG-UCI). In such a case, HARQ process ID corresponding to the first CG PUSCH TO can be determined using the following example equation: HARQ Process ID=[floor(CURRNT_Symbol/periodicity)]modulo nrofHARQ-Process. The HARQ process IDs corresponding to subsequent CG PUSCH TOs can be obtained by incrementing the HARQ process ID corresponding to the first CG PUSCH TO by a predefined number. According to some aspects, HARQ process ID can be determined using the above equation for Type 1 CG configuration as well as for Type 2 CG configuration. According to some aspects, an offset can be added to the above formula (e.g., HARQ Process ID=[floor(CURRNT_Symbol/periodicity)]modulo nrofHARQ-Process to allow more flexibility in HARQ ID allocation by the network. Alternatively, a HARQ ID can be configured by the network in the RRC signaling for the UE.

For Type 2 CG, HARQ process ID corresponding to the first CG PUSCH TO at Type 2 activation or the first CG PUSCH TO immediately after Type 2 activation can be determined using the following example equation: HARQ Process ID=[floor(CURRNT_Symbol/periodicity)] modulo nrofHARQ-Process. Furthermore, alternatively or additionally, a new field (e.g., a code-state field) can be defined to indicate the HARQ process ID for the first CG PUSCH TO.

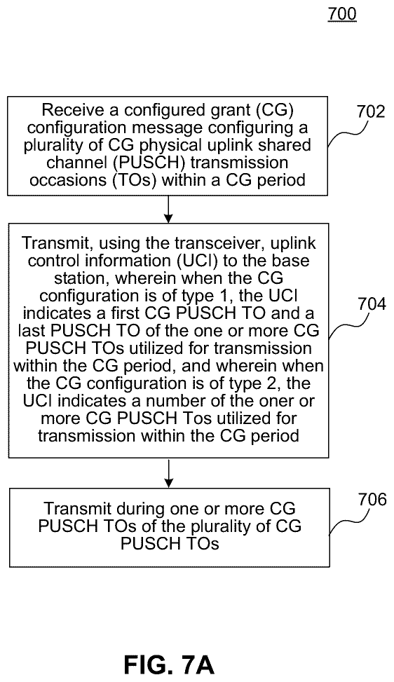

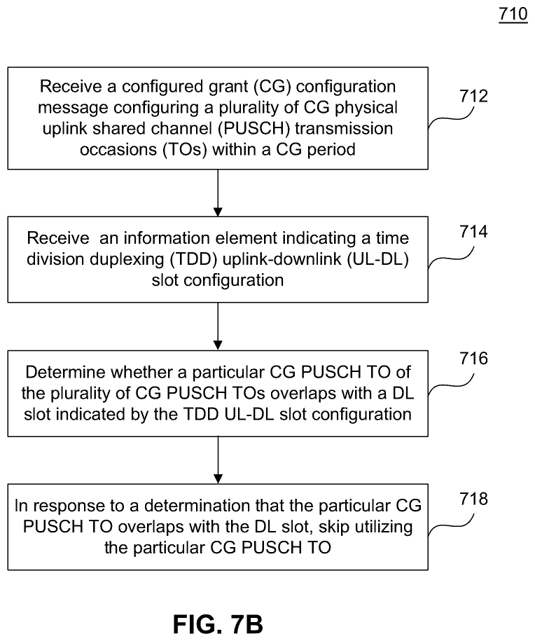

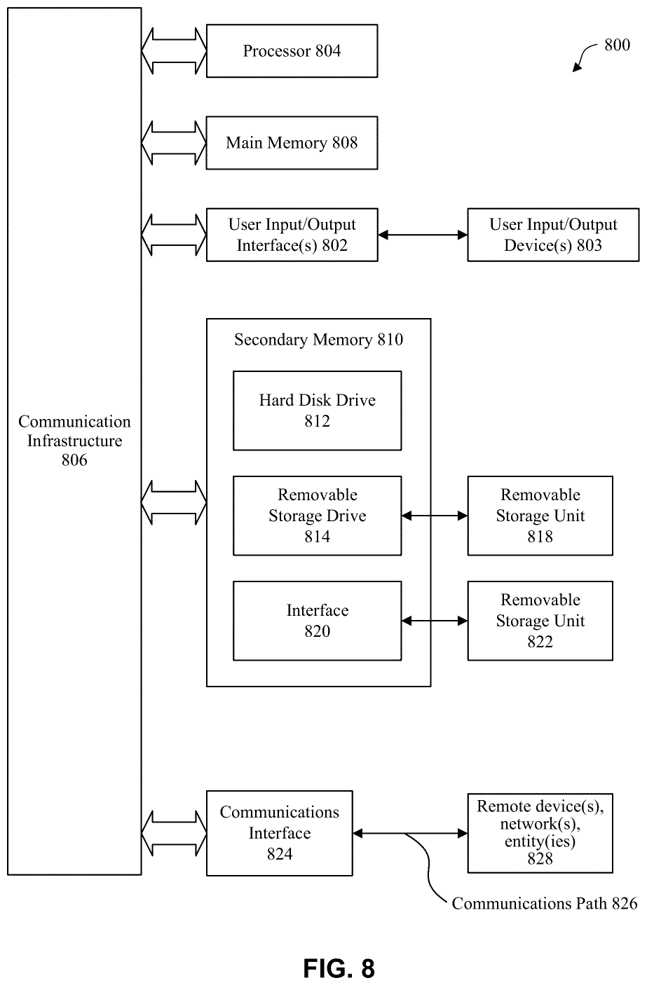

FIG. 7A illustrates an exemplary method 700 performed by a UE implementing enhanced configured grant transmissions, according to some aspects of this disclosure. As a convenience and not a limitation, FIG. 7A may be described with regard to elements of FIGS. 1-6 and 8, for example by UE 102. Method 700 may also be performed by system 200 of FIG. 2 and/or computer system 800 of FIG. 8. But method 700 is not limited to the specific aspects depicted in those figures, and other systems may be used to perform the method as will be understood by those skilled in the art. It is to be appreciated that not all operations may be needed, and the operations may not be performed in the same order as shown in FIG. 7A.

At 702, UE 102 receives a configured grant (CG) configuration message configuring a plurality of CG physical uplink shared channel (PUSCH) transmission occasions (TOs) within a CG period. According to some aspects, CG configuration can be of Type 1, and the CG configuration message is provided using RRC signaling. According to some aspects, CG configuration can be of Type 2, and the CG configuration message is provided using RRC signaling and a DCI that is received over a PDCCH.

At 704, UE 102 transmits, using the transceiver, an uplink control information (UCI). According to some aspects, when the CG configuration is of Type 1, the transmitted UCI indicates a first CG PUSCH TO and a last PUSCH TO of the CG PUSCH TOs utilized for transmission within the CG period. According to some aspects, UE 102 includes a code-state field in the CG UCI, and the code-state can be a numeric value that indicates the starting CG PUSCH TO and the ending CG PUSCH TO that were utilized during a CG period, as shown for example in FIG. 5.

Alternatively, when the CG configuration is of Type 2, at the activation of the CG configuration, the UCI indicates the number of the CG PUSCH TOs utilized for transmission within the CG period, according to some aspects. In this case, the first TO at the activation of the CG configuration is always utilized by the UE. According to some aspects, for Type 2 CG, UE 102 includes a code-state field in UCI, and the code-state can be a numeric value that indicates the number of CG PUSCH TOs that were utilized during a CG period. For a CG period after the activation, a similar procedure as for CG configuration of Type 1 may be performed, according to some aspects. Accordingly, for a CG period after the activation, the transmitted UCI indicates a first CG PUSCH TO and a last PUSCH TO of the CG PUSCH TOs utilized for transmission within the CG period. According to some aspects, UE 102 includes a code-state field in the CG UCI, and the code-state can be a numeric value that indicates the starting CG PUSCH TO and the ending CG PUSCH TO that were utilized during a CG period, as shown for example in FIG. 5. According to some aspects, UE 102 can transmit UCI with a code-state field over a PUCCH. Alternatively, UE 102 can transmit UCI with a code-state field over a PUSCH, according to some aspects.

At 706, UE 102 transmits, using the transceiver, PUSCH transmissions during one or more CG PUSCH TOs of the plurality of CG PUSCH TOs.

FIG. 7B illustrates another exemplary method 710 performed by a UE implementing enhanced configured grant transmissions, according to some aspects of this disclosure. As a convenience and not a limitation, FIG. 7B may be described with regard to elements of FIGS. 1-6 and 8, for example by UE 102. Method 710 may also be performed by system 200 of FIG. 2 and/or computer system 800 of FIG. 8. But method 710 is not limited to the specific aspects depicted in those figures, and other systems may be used to perform the method as will be understood by those skilled in the art. It is to be appreciated that not all operations may be needed, and the operations may not be performed in the same order as shown in FIG. 7B.

At 712, UE 102 receives a configured grant (CG) configuration message configuring a plurality of CG physical uplink shared channel (PUSCH) transmission occasions (TOs) within a CG period. According to some aspects, the CG configuration can be of Type 1, and the CG configuration message is provided using RRC signaling. According to some aspects, the CG configuration can be of Type 2, and the CG configuration message is provided using RRC signaling and a DCI that is received over a PDCCH.

At 714, UE 102 receives an information element indicating a time division duplexing (TDD) uplink-downlink (UL-DL) slot configuration. According to some aspects, the information element is received in a RRC SIB.

At 716, UE 102 determines whether a particular CG PUSCH TO of the plurality of CG PUSCH TOs overlaps with a DL slot indicated by the TDD UL-DL slot configuration.

At 718, in response to a determination that the particular CG PUSCH TO overlaps with the DL slot, UE 102 skips utilizing the particular CG PUSCH TO. Alternatively, in in response to a determination that the particular CG PUSCH TO does not overlap with the DL slot, the particular CG PUSCH TO is designated as an allowable CG PUSCH TO. UE 102 may utilize a CG PUSCH TO that is designated as an allowable CG PUSCH TO.

Various aspects can be implemented, for example, using one or more computer systems, such as computer system 800 shown in FIG. 8. Computer system 800 can be any well-known computer capable of performing the functions described herein such as UE 102 of FIG. 1. Computer system 800 includes one or more processors (also called central processing units, or CPUs), such as a processor 804. Processor 804 is connected to a communication infrastructure 806 (e.g., a bus). Computer system 800 also includes user input/output device(s) 803, such as monitors, keyboards, pointing devices, etc., that communicate with communication infrastructure 806 through user input/output interface(s) 802. Computer system 800 also includes a main or primary memory 808, such as random access memory (RAM). Main memory 808 may include one or more levels of cache. Main memory 808 has stored therein control logic (e.g., computer software) and/or data.

Computer system 800 may also include one or more secondary storage devices or memory 810. Secondary memory 810 may include, for example, a hard disk drive 812 and/or a removable storage device or drive 814. Removable storage drive 814 may be a floppy disk drive, a magnetic tape drive, a compact disk drive, an optical storage device, tape backup device, and/or any other storage device/drive.

Removable storage drive 814 may interact with a removable storage unit 818. Removable storage unit 818 includes a computer usable or readable storage device having stored thereon computer software (control logic) and/or data. Removable storage unit 818 may be a floppy disk, magnetic tape, compact disk, DVD, optical storage disk, and/any other computer data storage device. Removable storage drive 814 reads from and/or writes to removable storage unit 818 in a well-known manner.

According to some aspects, secondary memory 810 may include other means, instrumentalities or other approaches for allowing computer programs and/or other instructions and/or data to be accessed by computer system 800. Such means, instrumentalities or other approaches may include, for example, a removable storage unit 822 and an interface 820. Examples of the removable storage unit 822 and the interface 820 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 800 may further include a communication or network interface 824. Communication interface 824 enables computer system 800 to communicate and interact with any combination of remote devices, remote networks, remote entities, etc. (individually and collectively referenced by reference number 828). For example, communication interface 824 may allow computer system 800 to communicate with remote devices 828 over communications path 826, which may be wired and/or wireless, and which may include any combination of LANs, WANs, the Internet, etc. Control logic and/or data may be transmitted to and from computer system 800 via communication path 826.

The operations in the preceding aspects can be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 800, main memory 808, secondary memory 810 and removable storage units 818 and 822, as well as tangible articles of manufacture embodying any combination of the foregoing. Such control logic, when executed by one or more data processing devices (such as computer system 800), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 8. In particular, aspects may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more, but not all, exemplary aspects of the disclosure as contemplated by the inventor(s), and thus, are not intended to limit the disclosure or the appended claims in any way.

While the disclosure has been described herein with reference to exemplary aspects for exemplary fields and applications, it should be understood that the disclosure is not limited thereto. Other aspects and modifications thereto are possible, and are within the scope and spirit of the disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative aspects may perform functional blocks, steps, operations, methods, etc. using orderings different from those described herein.

References herein to “one aspect,” “aspects” “an example,” “examples,” or similar phrases, indicate that the aspect(s) described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein.

The breadth and scope of the disclosure should not be limited by any of the above-described exemplary aspects, but should be defined only in accordance with the following claims and their equivalents.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

What is claimed is:

1. A user equipment (UE), comprising:
a transceiver configured to enable wireless communication with a base station; and
a processor communicatively coupled to the transceiver and configured to:
receive a configured grant (CG) configuration message configuring a plurality of CG physical uplink shared channel (PUSCH) transmission occasions (TOs) within a CG period;
receive an information element indicating a time division duplexing (TDD) uplink-downlink (UL-DL) slot configuration;
determine whether a particular CG PUSCH TO of the plurality of CG PUSCH TOs overlaps with a DL slot indicated by the TDD UL-DL slot configuration; and
in response to a determination that the particular CG PUSCH TO overlaps with the DL slot, skip utilizing the particular CG PUSCH TO.

2. The UE of claim 1, wherein the processor is further configured to:
transmit, using the transceiver, uplink control information (UCI) to the base station, wherein the UCI indicates a first CG PUSCH TO and a last PUSCH TO of the plurality of CG PUSCH TOs utilized for transmission within the CG period; and
transmit, using the transceiver, PUSCH transmissions to the base station during one or more CG PUSCH TOs of the plurality of CG PUSCH TOs based on the UCI.

3. The UE of claim 2, wherein based on the CG configuration being Type 2, the UCI indicates a number of the plurality of CG PUSCH TOs at activation utilized for transmission, and the processor is further configured to:
determine a number of the plurality of CG PUSCH TOs configured within the CG period based on a number of the plurality of PUSCH transmissions indicated by a downlink control information (DCI).

4. The UE of claim 1, wherein the information element is received in a radio resource control (RRC) system information block (SIB).

5. The UE of claim 2, wherein the processor is further configured to:
receive a Physical Downlink Control Channel (PDCCH) transmission indicating a dynamic uplink grant, wherein the PDCCH transmission comprises a DCI configuring a plurality of PUSCH transmissions;
wherein a first PUSCH transmission of the PUSCH transmissions includes a UCI field indicating a number of one or more PUSCH transmissions of the plurality of PUSCH transmissions.

6. The UE of claim 1, wherein the processor is further configured to:
determine a hybrid automatic repeat request (HARQ) process identifier (ID) corresponding to a first CG PUSCH TO of the one or more CG PUSCH TOs based on a symbol index of the first CG PUSCH TO; and
increment the HARQ process ID corresponding to the first CG PUSCH TO by a predefined value to obtain a second HARQ process ID corresponding to a subsequent allowable CG PUSCH TO.

7. The UE of claim 1, wherein based on the CG configuration being Type 2, the processor is further configured to:
receive a PDCCH transmission comprising a DCI configuring a plurality of PUSCH transmissions within the CG period, wherein the DCI indicates a HARQ process ID corresponding to first PUSCH transmission of the plurality of PUSCH transmissions.

8. A method of operating a user equipment (UE), comprising:
receiving a configured grant (CG) configuration message configuring a plurality of CG physical uplink shared channel (PUSCH) transmission occasions (TOs) within a CG period;
receiving an information element indicating a time division duplexing (TDD) uplink-downlink (UL-DL) slot configuration;
determining whether a particular CG PUSCH TO of the plurality of CG PUSCH TOs overlaps with a DL slot indicated by the TDD UL-DL slot configuration; and
in response to a determination that the particular CG PUSCH TO overlaps with the DL slot, skipping utilizing the particular CG PUSCH TO.

9. The method of claim 8, further comprising:
transmitting, using the transceiver, uplink control information (UCI) to the base station, wherein the UCI indicates a first CG PUSCH TO and a last PUSCH TO of the plurality of CG PUSCH TOs utilized for transmission within the CG period; and
transmitting, using the transceiver, PUSCH transmissions to the base station during one or more CG PUSCH TOs of the plurality of CG PUSCH TOs based on the UCI.

10. The method of claim 9, wherein based on the CG configuration being Type 2, the UCI indicates a number of the plurality of CG PUSCH TOs at activation utilized for transmission, and further comprising:
determining a number of the plurality of CG PUSCH TOs configured within the CG period based on a number of the plurality of PUSCH transmissions indicated by a downlink control information (DCI).

11. The method of claim 8, wherein the information element is received in a radio resource control (RRC) system information block (SIB).

12. The method of claim 9, wherein the processor is further configured to:
receiving a Physical Downlink Control Channel (PDCCH) transmission indicating a dynamic uplink grant, wherein the PDCCH transmission comprises a DCI configuring a plurality of PUSCH transmissions,
wherein a first PUSCH transmission of the PUSCH transmissions includes a UCI field indicating a number of one or more PUSCH transmissions of the plurality of PUSCH transmissions.

13. The method of claim 8, wherein the processor is further configured to:
determining a hybrid automatic repeat request (HARQ) process identifier (ID) corresponding to a first CG PUSCH TO of the one or more CG PUSCH TOs based on a symbol index of the first CG PUSCH TO; and
incrementing the HARQ process ID corresponding to the first CG PUSCH TO by a predefined value to obtain a second HARQ process ID corresponding to a subsequent allowable CG PUSCH TO.

14. The method of claim 8, wherein based on the CG configuration being Type 2, the processor is further configured to:
receiving a PDCCH transmission comprising a DCI configuring a plurality of PUSCH transmissions within the CG period, wherein the DCI indicates a HARQ process ID corresponding to first PUSCH transmission of the plurality of PUSCH transmissions.

15. A non-transitory computer-readable medium (CRM) having instructions stored thereon that, when executed by a processor of a user equipment (UE), causes the UE to perform operations comprising:
receiving a configured grant (CG) configuration message configuring a plurality of CG physical uplink shared channel (PUSCH) transmission occasions (TOs) within a CG period;
receiving an information element indicating a time division duplexing (TDD) uplink-downlink (UL-DL) slot configuration;
determining whether a particular CG PUSCH TO of the plurality of CG PUSCH TOs overlaps with a DL slot indicated by the TDD UL-DL slot configuration; and
in response to a determination that the particular CG PUSCH TO overlaps with the DL slot, skipping utilizing the particular CG PUSCH TO.

16. The non-transitory CRM of claim 15, the operations further comprising:
transmitting, using the transceiver, uplink control information (UCI) to the base station, wherein the UCI indicates a first CG PUSCH TO and a last PUSCH TO of the plurality of CG PUSCH TOs utilized for transmission within the CG period; and
transmitting, using the transceiver, PUSCH transmissions to the base station during one or more CG PUSCH TOs of the plurality of CG PUSCH TOs based on the UCI.

17. The non-transitory CRM of claim 16, wherein based on the CG configuration being Type 2, the UCI indicates a number of the plurality of CG PUSCH TOs at activation utilized for transmission, and the operations further comprising:
determining a number of the plurality of CG PUSCH TOs configured within the CG period based on a number of the plurality of PUSCH transmissions indicated by the DCI.

18. The non-transitory CRM of claim 15, wherein the information element is received in a radio resource control (RRC) system information block (SIB).

19. The non-transitory CRM of claim 15, the operations further comprising:
determining a hybrid automatic repeat request (HARQ) process identifier (ID) corresponding to a first CG PUSCH TO of the one or more CG PUSCH TOs based on a symbol index of the first CG PUSCH TO; and
incrementing the HARQ process ID corresponding to the first CG PUSCH TO by a predefined value to obtain a second HARQ process ID corresponding to a subsequent allowable CG PUSCH TO.

20. The non-transitory CRM of claim 15, wherein based on the CG configuration being Type 2, the processor is further configured to:
receiving a Physical Downlink Control Channel (PDCCH) transmission comprising a DCI configuring a plurality of PUSCH transmissions within the CG period, wherein the DCI indicates a HARQ process ID corresponding to first PUSCH transmission of the plurality of PUSCH transmissions.
